(19) United States
(12) Patent Application Publication
(10) Pub. No.: US 2008/0168548 A1
(43) Pub. Date: Jul. 10, 2008

(54) Method For Automatically Controlling Access To Internet Chat Rooms

(76) Inventor: Amanda Jean O'Brien, Fredericksburg, VA (US)

Correspondence Address: Amanda J. O'Brien, 10706 Wellington Street, Fredericksburg, VA, 22407, US

(21) Appl. No.: 11/619,826

(22) Filed: Jan. 4, 2007

(51) Int. Cl. G06F 7/04

(52) U.S. Cl. 726/9

(57) ABSTRACT

A method is disclosed for authenticating user access to an Internet service such as a chatroom based on age appropriateness, wherein a user must provide officially verified age identification information to an access server of the Internet service in order to be granted access. The method comprises inserting an official secure identification card containing encrypted identification information into a secure identification card reader attached to the user's computer and transmitting the encrypted identification information to the access server, whereupon the access server compares the encrypted identification information to identification information maintained either by the access server or by a governmental identification card authentication server to which the access server is connected. This comparison verifies the age appropriateness of the Internet service for the user and the access server then grants or denies access to the user.

### FIELD OF THE INVENTION

The present invention relates generally to a method for automatically controlling access of an individual to a computer Internet service such as a chat room. The method is particularly suitable for controlling access by children and adults to chat room Internet sites which are targeted by online child sexual predators, and thus presents an effective means for diminishing the risk of an unsuspecting child or other individual becoming a victim of such sexual predators.

### BACKGROUND OF THE INVENTION

Parents, law enforcement officials, criminal justice agencies and lawmakers are in dire need of a method to reduce or eliminate the threats posed by on-line child predators. The number of children who become victims of on-line predators, through communications taking place in Internet chat rooms is increasing and has presented criminal justice officials with challenges regarding how to eliminate this dangerously increasing problem. Parents around the country have witnessed how easily a child can get involved in on-line chatting with strangers, which can and has led to inappropriate and sometimes criminal behavior. News officials have aired on national television stories of how these predators are caught in the act of trying to engage in inappropriate behavior with minors through means of Internet chat rooms. This threat to our children is real, and a method of prevention needs to be implemented that will limit the exposure of children to on-line child predators.

The Internet provides essentially unrestricted access to chat rooms, which are sites on a computer network where online conversations are held in real time by a number of users. In today's technology-based society, children spend a lot of their free time engaging in conversations with friends and strangers via chat rooms. Social networking Internet sites, on which children post descriptions of themselves and discuss intimate details of their lives, have become particularly popular. When a child participates in a chat room conversation or a social networking exchange, a sense of reality is lost. The fear of “talking” to a stranger does not exist as it did before the introduction of the World Wide Web. These virtual worlds are, in a sense, make believe, that is until a lurking child predator engages the child for criminal and/or sexual intentions.

As children meet new people in chat rooms, they are often persuaded to give out very personal information during these on line chat sessions. The “other” person often convinces the child that he or she is harmless, but in reality that person is interested in meeting the child for sexual or criminal purposes. This is unacceptable, and puts our children at risk. The moment a child engages in chatting on-line with someone from an older genre, the child has taken the bait and is at risk.

Currently, child protective programs and law enforcement agencies educate and warn children and parents of the dangers of on-line chatting. President George W. Bush has also recognized the need for protecting our children by signing the Adam Walsh Child Protection and Safety Act of 2006. There are many efforts underway to monitor the whereabouts of child predators, such as the implementation of databases, and keeping current with criminal records. There is also a known method which restricts access through the use of biometric bone scanning, a technology that identifies a person's age through scientific analysis of the bone, which is not a method that can be widely implemented in a cost efficient and easy manner. Even with the current efforts currently in place and underway, there is not an easily achievable method to prevent sexual predators from having access to our children within Internet chat rooms. As an example of how important it is to restrict access to age appropriate chat rooms, one merely needs to review age restricting activities currently enforced. Access of children to alcoholic beverages is restricted by age and authenticated through the use of an identification card. Access to cigarettes and tobacco products are also restricted by age and authenticated through the use of an identification card. Access to adult films and movies are likewise restricted by age and authenticated through the use of an identification card. In like manner, access to age appropriate chat rooms needs to be restricted by age and authenticated through the use of an identification card.

The United States Congress has passed the Real ID Act, which will require each state to comply with the implementation of a secure, technology based identification card for all United States residents. This Act will require proper identification and will force residents' information to be stored in a Government maintained database. One of the entries required for the identification card is the user's date of birth. In order to implement the method of the present invention, a user will be required to use the Government issued identification card in order to obtain access to the age appropriate chat room. The method of this invention will prevent lurking on-line child predators from having access to children in chat rooms.

Children will continue to become victims of on-line sexual and criminal predators unless action is taken and methods are put in place to prevent the predators from having access to children in chat rooms.

### DESCRIPTION OF THE RELATED PRIOR ART

A method and apparatus for controlling the access of individuals to a service such as an Internet chat room site, the controlled access being based on the individual's particular age and/or gender category, is disclosed in published PCT Application WO 02/071765 A2. In this method, predetermined biometric characteristics of the individual, such as bone density or bone growth-plate presence, are machine sensed by means of an ultrasonic sensing device designed to be attached to a computer. Such ultrasonic sensing devices, however, are not widely commercially available at a reasonable cost for the average parent. Moreover, this method of controlling access does not rely on a government maintained database for verification of sensed identification information.

U.S. Letters Pat. No. 6,421,453 discloses a method for controlling the access of individuals to an Internet service by means of a predefined series of intentional gestures which are unique to a given individual. This method is cumbersome, however, and would be difficult to implement in practice. It must be used in combination with some sort of secure identification card, and thus does not afford the simplicity and ease of use associated with the method of the present invention.

Published PCT Application WO 03/030445 A1 discloses a general method of authenticating access of individuals to a service (which could be an Internet service) involving the use of a smart card. This method, though, does not address age-appropriate classification of Internet chat rooms, age-appropriate identification/authentication, or the use of a government maintained database for verification of secure identification information.

U.S. Letters Pat. No. 6,901,379 discloses a method of registration for access to an Internet chat room, but has nothing to do with age-appropriate identification/authentication resulting in access approval or denial.

U.S. Letters Pat. No. 6,929,544 discloses another method of authenticating access to an Internet chat room involving shared data communication with a database server, but does not address age-appropriate identification/authentication resulting in access approval or denial.

U.S. Letters Pat. No. 7,073,058 discloses an authentication method for connection of a user to an Internet service.

U.S. Letters Pat. No. 7,085,924 discloses another authentication method for connection of a user to an Internet service.

United States Patent Application Publication 2004/0003071 A1 discloses an interactive filtering method for controlling access to particular Internet sites (a “blocking” method), which can be used by parents to ensure age-appropriate access. This method, however, is not universally effective for Internet chat rooms, since parents must designate individual sites for blocked or restricted access.

United States Patent Application Publication 2006/0106836 A1 provides a general suggestion of the use of a security identification chip (USC) in an interactive authentication process for accessing an Internet chat room.

### SUMMARY OF THE INVENTION

The present invention provides a method of controlling access of an individual to chat room services on the Internet by restricting access to users of a particular category, such as the age of the user. Through the use of standard issued Government identification cards, card readers and authentication software, the access to age appropriate chat rooms will be controlled.

Chat room service providers will determine the age appropriateness of each chat room provided thereby, and will classify it into one of three categories: (1) age 17 and younger, (2) age 18 and older, and (3) no age restriction. These age group classifications thus categorize chat rooms and respectively provide forums for child-appropriate chat activities, adult-appropriate chat activities, and other chat activities where on-line predators do not pose a risk. This will provide the underlying basis for the following specific steps of the method used to authenticate the user prior to allowing entry to a chat room.

When the chat room is classified as a Category (1) chat room, only those who are 17 or younger will be permitted to join in the chat room and participate in chatting. When the chat room is classified as a Category (2) chat room, only those who are 18 or older will be permitted to join in the chat room and participate in chatting. When the chat room is classified as a Category (3) chat room, anyone will be authorized to participate in chatting.

By use of a Government issued identification card including a data chip which contains the user's date of birth, authentication of the user will occur when attempting to gain access to a chat room. The user will employ his or her secure Government issued identification card in conjunction with a commercially available secure identification card reader. As already mentioned, the secure identification card is a Government sponsored card, which has encrypted therein the user's name and date of birth. The user will obtain such Government issued identification card through a local, state, or national government agency, such as the state Department of Motor Vehicles or the U.S. Immigration & Naturalization Service, as required by the Real ID Act (discussed above) which was enacted in May 2005. This Act requires that all persons be issued a national identification card by the year 2008.

The chat room providers will be equipped with software provided by a secure identification card vendor. This software will allow the chat room provider to communicate with the secure identification card server, maintained by a Government agency, and will serve as the authenticating authority when a user attempts to gain access to a chat room.

Many governmental agencies, such as various states' Department of Motor Vehicles, are currently moving towards using secure identification card technology for the issuance of drivers licenses and identification cards for meeting the requirements of the 2005 Real ID Act. The automatic control of access to Internet chat rooms can be implemented in the homes of anyone who owns a personal home computer, at very little cost to the consumer. The user simply purchases a computer accessory package, including a secure identification card reader and associated software in order to access those chat rooms which have classified age restriction access. The identification card reader will easily adapt as an accessory to the user's personal computer through a USB or similar connection. The software is easily installed on the personal computer.

The Internet chat room hosts will identify and classify which chat rooms are adult chat rooms, and which rooms are meant for children. If the chat room is for general educational research or otherwise not a consideration for the purpose of the software, such chat room is not included in the program. A simple software application will allow the authentication process to work when users load the software onto their computer.

### BRIEF DESCRIPTION OF THE DRAWINGS

The invention is herein described, by way of example only, with reference to the accompanying drawings. With specific reference not to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for fundamental understanding of the invention, the description taken with the drawings making apparent to those skilled in the art how the invention may be embodied in practice.

In the drawings:

FIG. 1 is a general process flow of the implementation of a method for controlling access to Internet chat rooms in accordance with the present invention.

FIG. 2 is a perspective view of an exemplary Government issued secure identification card.

FIG. 3 is a perspective view of a standard commercially available secure identification card reader attached to a personal computer.

### DETAILED DESCRIPTION OF THE INVENTION

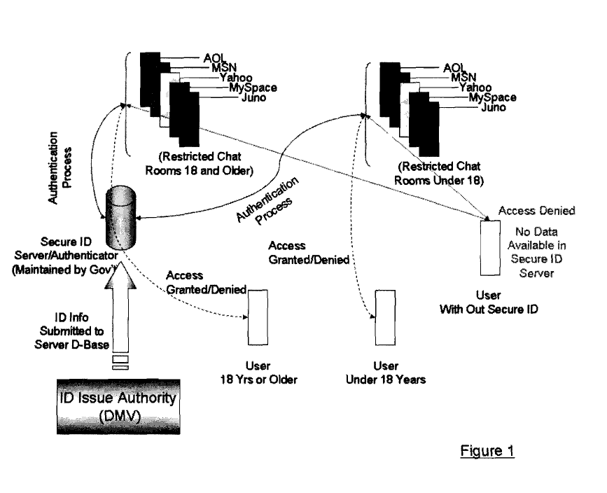

The specific steps of a method for automatically controlling access of an individual to a computer Internet service such as a chat room, particularly for controlling access by children and adults to chat room Internet sites which are targeted by online child sexual predators, are illustrated through the general process flow shown in FIG. 1.

Initially, participating chat room providers classify their chat rooms according to age appropriateness. The chat room providers install any software and hardware which may be required to communicate with a Government issued secure identification card authentication database server. Some of the more well known chat room providers which presently exist include AOL, MSN, Yahoo, MySpace, and Juno. This is not, of course, an exhaustive list.

Users who are interested in protecting their children from on-line predators obtain, for each child, a Government issued secure identification card at a governmental agency such as those described above. Users will be required to provide proof of identification just as they do when obtaining a drivers license.

The Government agency then submits the user's information to the secure identification card server, which will be the central point of communication with chat room providers for authentication of users.

The user purchases a secure identification card reader and associated software for installation on his or her home computer, and accesses the Internet in the usual manner through an Internet service provided (ISP). When attempting to enter an Internet chat room site that is restricted by age, the user follows the chat room provider's instructions indicated on the computer screen. At some point during these instructions, the user will be required to insert their identification card in order for authentication to occur.

For example, a user enters a chat room. Prior to being allowed to join in the discussions, the user is prompted to insert his or her Government issued identification card into a card reader, which will identify the user's age. If the user is within the authorized age group, access is granted to the chat room. If the user is not within the authorized age group, access is denied.

Parental supervision is always available by using existing commercial off-the-shelf software. Such parental control software products are currently being used to monitor a child's computer usage activity. However, this does not allow for real-time access to a child's activity while participating in chat room discussions.

While the use of such monitoring software is laudable, and is certainly compatible with the present invention, it does not allow for the kind of prevention needed to intercept dangerous and potentially criminal actions. A parental override feature of the present invention advantageously allows parents to have access to a child's computer usage during chat sessions. This invention's parental override feature takes the form of an additional prompt for the parent to insert his or her Government issued identification card into a card reader. Data encrypted on both the child's and the parent's secure identification cards is used to verify parental status to allow grant or denial of access.

In accordance with the method, interactive data transmission occurs between the secure identification card server (maintained by a governmental authority) and the verification hardware/software of the Internet chat room providers. A data comparison operation occurs when a user seeks access in the manner just described. The encrypted data received by the Internet chat room provider from the user's secure identification card is compared with the data maintained by the secure identification card server. If the data comparison indicates that the requesting user meets the criteria for access to the age restricted chat room, then the user is notified and access is granted. If, on the other hand, the data comparison indicates that the requesting user does not meet the criteria for access to the age restricted chat room, then the user is notified and access is denied.

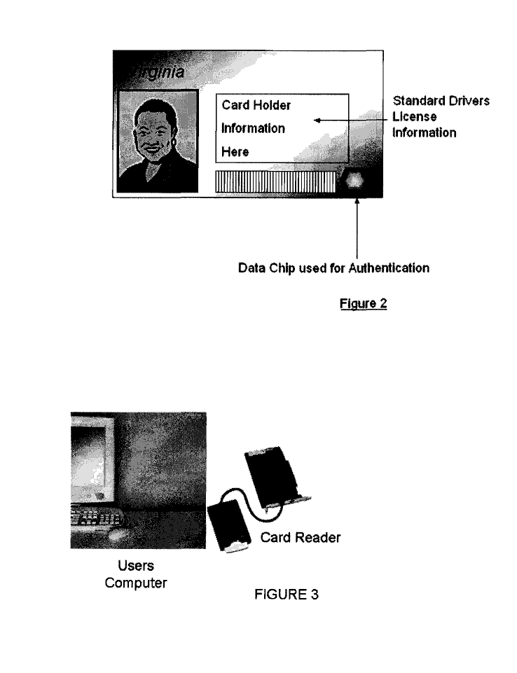

FIG. 2 illustrates a typical secure identification card in use throughout business and government today, and which is likely the form in which those secure identification cards required by the 2005 Real ID Act (and which will be used in conjunction with the method of the present invention) will appear. A typical secure identification card includes pictorial and written information describing the individual, as is evident in the drawing. More importantly for the purposes of this invention, however, the secure identification card has imbedded therein a data chip which contains encrypted information describing the individual. Such encrypted information is in a format that can be read only by a secure identification card reader, shown in FIG. 3. While identification cards containing only pictorial and written information are susceptible to forgery and fraud (and thus manipulation of accurate age identification information), an encrypted data chip is not susceptible to these criminal problems. The use of these types of secure identification cards is therefore becoming more widespread.

The secure identification card reader shown in FIG. 3 is a commercially available, off-the-shelf, reasonably priced computer peripheral device designed to be plugged into a USB or similar port of a personal computer. In terms of simplicity of understanding and ease of use, such a secure identification card reader would be much like a digital camera card reader.

### CONCLUSION

Parents are concerned about the ever increasing statistics of children becoming victims of on-line predators. Parents cannot be there every minute of the day with our children, and parents cannot trust our children to tell us everything they do. The method of this invention is an easy way to assist in the prevention of something horrible happening to our children. As proven and shown on network television, the on-line predators are out there, and they are not afraid to go after our children. Our children are easy targets, and an efficient and easily implemented method must be put in place to fight these crimes. The inventive method for automatically controlling access to Internet chat rooms can keep these predators from chatting with and having access to our children on-line. This will prove to be a huge step forward in crime prevention. Parents and crime prevention officials across the country will sleep better knowing this protection is in place while our children are using the Internet chat rooms.

While exemplary aspects and embodiments of the invention have been discussed above, those of ordinary skill in the art will recognize certain modifications, permutations, and additions thereof. For example, computer software tools or processes other than those described herein may be employed without departing from the scope of this invention. Secure identification cards other than the types specifically mentioned herein (for example secure identification cards utilizing “biometric” technology) may likewise be employed without departing from the scope of this invention. Similarly, age group classifications may be other than those specifically enumerated herein without departing from the scope of the invention. It is therefore intended that the claims which follow are interpreted to include all such modifications, permutations, and additions as are within their true spirit and scope.

1. An interactive method for authenticating user access to an Internet service based on age appropriateness for a potential user, wherein the method involves queries and responses between a remote computer of the potential user and an access server of the Internet service, the method comprising:
determination of age appropriateness of said Internet service by a provider of said Internet service;
classification of said age appropriateness into one of three categories, said categories being (a) age 17 and younger, (b) age 18 and older, and (c) no age restriction;
request by said potential user for access to the Internet service from said remote computer;
reply by said access server requesting age verification from said potential user;
insertion of a secure identification card containing encrypted identification information of said potential user into a secure identification card reader attached to said remote computer;
transmission of said encrypted identification information of said potential user from said secure identification card reader to said access server;
receipt of said transmitted encrypted identification information by said access server;
comparison of said transmitted encrypted identification information to identification information maintained by said access server;
verification of the age appropriateness of the Internet service for the potential user based on said comparison; and
grant or denial of Internet service access to said potential user based on said verification.

2. The method of claim 1, wherein said Internet service is an Internet chat room site.

3. The method of claim 1, wherein said Internet service is a social networking interface.

4. The method of claim 1, wherein said secure identification card containing encrypted identification information of said potential user is a local government issued identification card.

5. The method of claim 1, wherein said secure identification card containing encrypted identification information of said potential user is a state government issued identification card.

6. The method of claim 1, wherein said secure identification card containing encrypted identification information of said potential user is a national government issued identification card.

7. (canceled)

8. The method of claim 1, wherein said comparison step comprises comparison of said transmitted encrypted identification information to identification information maintained in a database associated with a governmental identification card authentication server.

9. An interactive method for authenticating user access to an Internet service based on age appropriateness for a potential user, wherein the method involves queries and responses between a remote computer of the potential user and an access server of the Internet service, the method comprising:
request by said potential user for access to the Internet service from said remote computer;
reply by said access server requesting age verification from said potential user;
insertion of a secure identification card containing encrypted identification information of said potential user into a secure identification card reader attached to said remote computer;
transmission of said encrypted identification information of said potential user from said secure identification card reader to said access server;
receipt of said transmitted encrypted identification information by said access server;
comparison of said transmitted encrypted identification information to identification information maintained by said access server;
verification of the age appropriateness of the Internet service for the potential user based on said comparison;
grant or denial of Internet service access to said potential user based on said verification;
request by said potential user, upon initial denial, for access to the Internet service from said remote computer based on parental status;
reply by said access server requesting parental verification from said potential user;
re-insertion of said secure identification card containing encrypted identification information of said potential user into said secure identification card reader attached to said remote computer;
transmission of said encrypted identification information of said potential user from said secure identification card reader to said access server;
receipt of said transmitted encrypted identification information by said access server;
comparison of said transmitted encrypted identification information to said identification information maintained by said access server;
verification of acceptable parental status for the potential user based on said comparison; and
grant or denial of Internet service access to said potential user based on said verification.
